(19) United States
(12) Patent Application Publication
(10) Pub. No.: US 2006/0037790 A1
(43) Pub. Date: Feb. 23, 2006

(54) Industrial truck having ergonomically arranged operating elements

(76) Inventors: Wolfgang Haack, Hamburg (DE); Michael Niebuhr, Bargteheide (DE); Carsten Schottke, Moosburg (DE)

Correspondence Address: EDWARDS & ANGELL, LLP, P.O. BOX 55874, BOSTON, MA, 02205, US

(21) Appl. No.: 11/199,684

(22) Filed: Aug. 9, 2005

(30) Foreign Application Priority Data
Aug. 20, 2004 (DE) 10 2004 040 457.7

(51) Int. Cl. B62D 51/04

(52) U.S. Cl. 180/19.1

(57) ABSTRACT

An industrial truck having a steering wheel (14) which can be rotated about a steering wheel axis of rotation (18), the steering wheel axis of rotation (18) being rotated a predetermined angle of rotation (α) with respect to an imaginary plane (LME), which is orthogonal with respect to a standing area for the industrial truck, passes through a driver's platform (12) and extends in the longitudinal direction of the industrial truck, about a rotational axis (20) which is essentially orthogonal with respect to the standing area and lies on the imaginary plane, is characterized in that the steering wheel axis of rotation (18) is rotated away from the driver, the rotational axis (20) being positioned in the forward travel direction (VF) of the industrial truck, when viewed from the driver's platform (12).

The present application relates to an industrial truck having ergonomically arranged operating elements. These operating elements are, in particular, a steering wheel and switches.

Correspondingly, the present invention in accordance with a first aspect relates to an industrial truck having a steering wheel which can be rotated about a steering wheel axis of rotation, the steering wheel axis of rotation being rotated a predetermined angle of rotation with respect to an imaginary plane, which is orthogonal with respect to a standing area for the industrial truck, passes through a driver's platform and extends in the longitudinal direction of the industrial truck, about a rotational axis which is essentially orthogonal with respect to the standing area and lies on the imaginary plane.

Such industrial trucks are generally known. For example, an industrial truck is known in which operating elements, such as the above-described steering wheel, inter alia, are arranged on a convexly curved (when viewed from the driver's platform) control panel such that they are inclined towards the driver.

One disadvantage of this arrangement of the steering wheel is the fact that the driver of the industrial truck, although the axis of rotation of the steering wheel points towards him, needs to position his hands to rotate the steering wheel, and this may not favour rapid rotation of the steering wheel sufficiently or, after a certain amount of time, may lead to signs of tiring.

A first object of the present invention is therefore to provide an industrial truck of the type mentioned initially in which the steering wheel is arranged more ergonomically than in a prior art such that rapid rotation of the steering wheel and actuation of the steering wheel which is subject to less tiring are possible even over a long period of time.

This object is achieved according to a first aspect of the present invention by a generic industrial truck in which the steering wheel axis of rotation is rotated away from the driver, the rotational axis being positioned in the forward travel direction of the industrial truck, when viewed from the driver's platform.

In contrast to the prior art, with the industrial truck of the present invention the axis of rotation of the steering wheel is pivoted away from the driver, i.e. it extends past the driver who is located on the driver's platform of the industrial truck.

“Driver's platform” is in this case an area which is taken up by a driver during driving operation of the industrial truck. This area taken up by the driver can be determined on the basis of the arrangement of the operating elements and the field of vision which the industrial truck offers.

If the rotational axis, about which the axis of rotation of the steering wheel is rotated, is upstream of the driver's platform in the forward travel direction of the industrial truck (in this case the forward travel direction is also the direction in which the driver of the industrial truck is looking during forward travel), a steering wheel plane which is orthogonal with respect to the steering wheel axis of rotation does not point towards the driver, as in the prior art, but towards an outer side of the industrial truck, to be more precise the steering wheel plane firstly points in the reverse travel direction and secondly in the lateral direction of the industrial truck, away from the driver's platform.

Since the steering wheel is generally not formed, as in the case of a motor vehicle, by a ring which can be gripped by hands but has an essentially planar disc having a handle which generally protrudes orthogonally with respect to the plane of the disc, said handle, which generally extends parallel to the axis of rotation of the steering wheel, can be gripped in a natural position for the hands of the driver, and the steering wheel can thus be operated ergonomically.

The steering wheel handle can be rotated in relation to the steering wheel disc for the purpose of making it easier to rotate the steering wheel, preferably about a handle axis of rotation which is parallel to the axis of rotation of the steering wheel.

Since the driver's platform is the reference point for arranging operating elements for the industrial truck, in accordance with a general concept of the invention, an imaginary plane, which passes through the driver's platform, is orthogonal with respect to the standing area for the industrial truck and extends in the longitudinal direction of the industrial truck, is a reference plane for the purpose of describing the arrangement of the steering wheel. In this case, however, the industrial truck can be controlled particularly easily if the driver's platform is in the transverse centre of the industrial truck, since in this case the right-hand and the left-hand side edge of the industrial truck are the same distance apart from the driver of the industrial truck, and the driver of the industrial truck can thus drive the vehicle more easily through narrow gaps than in the case of an off-centre arrangement of the driver's platform. For this reason, the imaginary plane is preferably a longitudinal central plane of the industrial truck. In this case, the longitudinal central plane is a central plane, which extends in the longitudinal direction of the industrial truck and is essentially orthogonal with respect to the standing area for the industrial truck, i.e. the plane lying in the transverse centre of the industrial truck.

Where it has previously been said that the steering wheel axis of rotation is rotated about a rotational axis which is essentially orthogonal with respect to the standing area, this should not rule out the possibility of the steering wheel axis of rotation also being rotated about a further rotational axis which is orthogonal with respect to the rotational axis mentioned. It is merely necessary to ensure that the steering wheel axis of rotation is rotated about the abovementioned rotational axis.

In fact, it has been shown that the steering wheel can be actuated in a particularly user-friendly manner if the plane of the steering wheel is arranged orthogonally with respect to the standing area for the industrial truck, i.e. if the steering wheel axis of rotation is oriented essentially parallel to the standing area.

Depending on the type of operator, in the case of a relaxed, open hand which is held with slightly bent arms, an imaginary line, which passes inbetween the thumb and the other four fingers of the hand, points at a different angle of inclination with respect to a longitudinal central plane of the body of the relevant operator. Depending on the position of the hands, the imaginary line intersects the longitudinal central plane of the body of the operator at a different distance, but always in front of the operator. It has been shown here that an ergonomically favourable arrangement of the steering wheel axis of rotation close to the above-described imaginary line lies in a range for the angle of rotation of 5 to 15° in relation to the imaginary reference plane. The steering wheel axis of rotation is particularly preferably rotated approximately 10° in relation to the imaginary plane. Only the degrees of the angles are of significance here, since the steering wheel can be arranged to the left of the imaginary plane for operation using the left-hand of a driver or to the right of the imaginary plane for operation using the right hand of the driver, when viewed from the driver's platform.

The steering wheel is preferably not mechanically connected to wheels which can be steered but is merely electronically connected to them. Steering commands, as a result of a rotation of the steering wheel, are thus detected by a rotation sensor, passed on to a control unit and converted there into command signals for corresponding steering actuators. As a result, the steering wheel can be kept very small in terms of its diameter.

In accordance with a further aspect of the present invention, which is independent of that cited above, this invention relates to an industrial truck having a handle part, on which a first switch is provided for the purpose of controlling a controllable first component of the industrial truck such that it can be reached and actuated by a first finger of the hand gripping the handle part when a handle section of the handle part is gripped by a hand.

However, express reference will be made to the fact that this further aspect can be implemented, and preferably is implemented, not only as an alternative but also in addition to the ergonomically arranged steering wheel on an industrial truck.

Industrial trucks by Jungheinrich having the mentioned handle parts have been known for a long time and are successful in use.

The object of the present invention is to further improve the known industrial trucks in terms of their operability and thus to increase the convenience of operation.

In this case, consideration should be taken of the fact that the first switch often controls the drive of the industrial truck such that, depending on the switch position, the industrial truck can be transferred to forward or reverse travel, it moreover being possible for the speed of the industrial truck to be controllable by the degree to which the first switch has been deflected from a rest position. In this case, it is advantageous if the driver of the industrial truck can operate this switch while he grips the handle section of the handle part with one hand, with the result that he has a secure hold on the industrial truck when said industrial truck is travelling.

The abovementioned object is achieved in the case of a generic industrial truck by a second switch which is separate from the first switch being provided on the industrial truck for the purpose of controlling a controllable second component, which is different from the first component, of the industrial truck such that it can be reached and actuated by a second finger, which is different from the first finger, of the hand gripping the handle part when the handle section of the handle part is gripped by the hand.

The abovementioned arrangement of the second switch makes it possible for a further component of the industrial truck to likewise be controlled without the driver needing to release the handle section or slide his hand over said handle section. He therefore permanently has a secure hold on the industrial truck, at the same time provision being made for both the first and the second switch to be operable with in each case only one finger of the hand gripping the handle part.

In this case, the bodily dimensions of an adult, preferably male person of average growth are used as the basis for the dimensions.

The first component of the industrial truck may, in this case, be the industrial truck drive, and the second component may be the lifting drive for a load displacement means of the industrial truck, with the result that the driver of the industrial truck can, without releasing the handle section of the handle part or without loosening his tight grip, drive up to a load, receive the load which he has approached, using a load displacement means, having received it lift it up, transport it to a desired stacking location, set it down there at a desired height and begin another operation.

“Switches” in the context of the present application are generally operating elements which can output, in the event of a change in their orientation, a signal which corresponds to the change and/or the new orientation. This should also include a single switch which can be switched merely between two switching positions.

In order to ensure that both the first switch and the second switch can be actuated with, in each case, only one finger, the first switch and the second switch are rotary switches which can be actuated by rotating them about respective rotary switch axes. Rotary switches have the advantage that they can be formed with any desired suitable radial length in relation to the respective rotary switch axis such that, owing to the lever effect, a low force, which can be applied using only one finger, is sufficient for actuating the switch. In addition, the radial length which can be selected means that a rotary switch can be arranged as a pushbutton switch, which is likewise possible in principle, with greater freedom with respect to the application site.

The first rotary switch may be formed in a manner known per se and in a manner which is particularly favourable in ergonomic terms such that the handle section is approximately symmetrical, at least in sections, with a handle section direction of extent, in particular a handle section central axis, the rotary switch axis of the first rotary switch extending essentially parallel, preferably even essentially coaxially, with respect to the handle section direction of extent, in particular the handle section central axis. In this case, the first rotary switch can be actuated very easily using the thumb of the hand gripping the handle section. For this purpose, the first rotary switch is preferably provided at an axial longitudinal end of the handle part or of the handle section.

The second rotary switch is in this case advantageously arranged such that it can be reached and actuated using the index finger of the hand gripping the handle section. This has the advantage, on the one hand, that thumbs and index fingers are generally the most movable fingers of a hand and can be moved very easily in a targeted manner automatically, without the need for practice. The actuation of the first and of the second switch using the thumb or index finger, however, also has the advantageous effect of three adjacent fingers of the hand gripping the handle section, namely the middle finger, the ring finger and the little finger, forming a continuous hand area which grips the handle section such that there is always sufficient holding force available even when the first rotary switch and the second rotary switch are being actuated.

Ergonomic investigations have shown that the second rotary switch can be actuated particularly easily by only one finger, in particular by the index finger, of the hand gripping the handle section if the rotary switch axis of the second rotary switch is tipped at an angle of −5° to +10°, preferably 0° to +7.5°, particularly preferably approximately 5°, with respect to the rotary switch axis of the first rotary switch about a tipping axis which is essentially orthogonal with respect to the standing area for the industrial truck, the rotary switch axis of the first rotary switch acting as the reference axis, from where positive angles are measured in the anticlockwise direction.

In addition to the relative orientation of the rotary switch axis of the second rotary switch with respect to that of the first rotary switch, the absolute arrangement of the rotary switch axis of the second rotary switch also plays a significant role in terms of ergonomic actuation. In this case, it has been shown that a low actuating force for actuating the second rotary switch is required if the rotary switch axis of the second rotary switch encloses, with a reference plane, which is orthogonal both with respect to the longitudinal direction of the industrial truck and with respect to its standing area and contains the point of intersection between the rotary switch axis of the second rotary switch and the longitudinal central plane of the industrial truck, an angle of approximately 15° to 30°, preferably from 20° to 25°, particularly preferably of approximately 23°, whereby positive angles are intended to be measured from the reference plane in the clockwise direction.

Since the handle part is generally arranged between the waistline and the chest area of an adult operator of average height, the second switch, irrespective of whether it is a rotary switch, a pushbutton switch or the like, can be reached in a very short period of time and can be actuated using little force by one finger if the second switch is arranged lower than the first switch in relation to the standing area for the industrial truck.

Since, furthermore, when the handle section is gripped the thumb of the driver of the industrial truck is positioned closer to his body than his index finger, it is advantageous for force-saving actuation of the first switch and of the second switch if the first switch is arranged upstream of the second switch in the longitudinal direction of the industrial truck, when viewed from the driver's platform of the industrial truck.

The industrial truck is preferably provided with a control panel which comprises a steering wheel having at least one of the abovementioned features and/or which comprises a first and a second switch having at least one of the abovementioned features. The control panel preferably comprises both a steering wheel, a first switch and a second switch such that the control panel can be attached to the industrial truck or can be replaced on said industrial truck as a preassembled module or one which can be preassembled.

The present invention will be described in more detail below with reference to a preferred embodiment of the present invention. In the drawing:

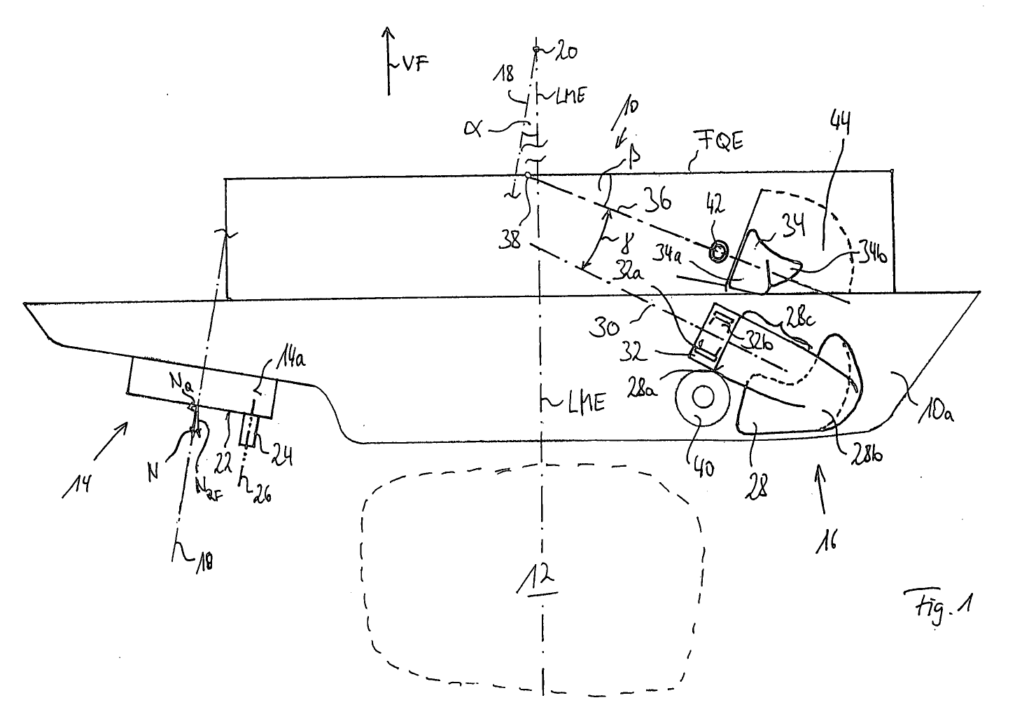

FIG. 1 shows a plan view of a control panel of an industrial truck according to the invention, and

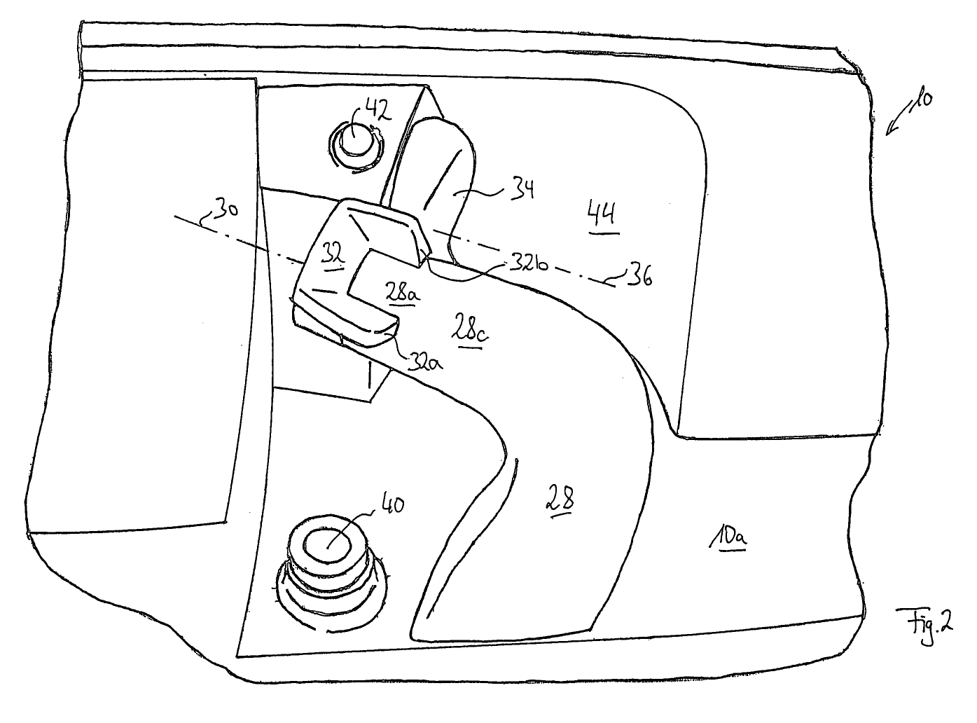

FIG. 2 shows a perspective view of a section of the control panel having a handle part, a first switch and a second switch.

In FIG. 1, a control panel of an industrial truck (which is not shown in any more detail) is overall given the reference 10, schematically and in plan view.

Those skilled in the art will understand that the control panel 10 comprises more than the operating elements illustrated. For reasons of simplicity and clarity, only the components which are essential to the present invention are illustrated.

The plane of the drawing in FIG. 1 is parallel to the standing area for the industrial truck which bears the control panel 10. Furthermore, the forward travel direction of the industrial truck according to the invention is indicated by the arrow VF.

Indicated downstream of the control panel 10 in the forward travel direction VF using dashed lines is a driver's platform 12. A driver is located at this point during driving operation of the industrial truck such that he can operate the steering wheel 14 with his left hand and the switch arrangement 16 with his right hand.

A longitudinal central plane, which extends in the longitudinal direction of the industrial truck, is orthogonal with respect to the standing area for the industrial truck and with respect to the plane of the drawing in FIG. 1 and passes through the transverse centre of the industrial truck, is denoted LME in FIG. 1. This longitudinal central plane passes through the driver's platform 12 essentially symmetrically such that the industrial truck has essentially the same extent to the right-hand side and to the left-hand side of the driver. This makes manoeuvrability of the industrial truck easier.

The steering wheel 14 rotates about a steering wheel axis of rotation 18 which is essentially parallel to the standing area for the industrial truck. This steering wheel axis of rotation is rotated a predetermined angle α about a rotational axis 20 which is essentially orthogonal with respect to the standing area for the industrial truck and with respect to the plane of the drawing in FIG. 1. In the example illustrated, the angle α is approximately 10°. The rotational axis 20 lies completely on the longitudinal central plane which, in the example illustrated, is the reference plane for the purpose of determining a rotation of the steering wheel axis of rotation 18.

Since the steering wheel axis of rotation 18 intersects the longitudinal central plane at a relatively great distance in front of the control panel 10, the illustration of the longitudinal central plane in FIG. 1 is shown shortened and not to scale.

The steering wheel 14, to be precise a normal vector N, normal with respect to a steering wheel plane 22, which is orthogonal with respect to the axis of rotation 18, points in the reverse travel direction (component N_{RF}) and also points in the transverse direction (component N_{Q}) of the industrial truck, away from the driver's platform 12.

This has the advantage that a driver who is on the driver's platform 12 and who grips the handle pin 24 of the steering wheel 14 with his left hand with slightly bent arms can do this in a natural position for the hands such that he tires less rapidly when actuating the steering wheel 14 and can possibly actuate the steering wheel 14 more quickly than in the prior art. The handle pin 24 protrudes parallel to the steering wheel axis of rotation 18 from the steering wheel plane 22, which is orthogonal with respect to the axis of rotation 18, towards the driver's platform side and can be rotated with respect to the steering wheel 14 about a handle pin axis of rotation 26 which is parallel to the steering wheel axis of rotation 18. This makes it possible to prevent an outer surface of the handle pin 24 sliding in relation to the skin when the steering wheel 14 is rotated and possibly injuring the driver.

Furthermore, the outer surface 14a of the steering wheel 14 is corrugated or formed in another way so as to increase friction such that a driver, if he so desires, can also grip and rotate the steering wheel using this outer surface.

In the embodiment shown in FIG. 1, a handle part 28 is provided on the control panel 10 and protrudes upwards in the form of a horn from a control panel surface 10a, the handle part 28 being curved such that the free longitudinal end 28a of the handle part 28 points forwards and towards the longitudinal central plane LME of the industrial truck.

The edge, which is hidden in the plan view by the handle part 28, of the attachment face 28b of the handle part 28 on the control panel surface 10a is illustrated using dashed lines.

The handle part 28 has, in its region which is close to the free longitudinal end 28a, a handle section 28c which, during operation of the industrial truck, can be gripped by the right hand of the driver. Gripping of the handle section 28c takes place in this case such that the four fingers from the index finger to the little finger of the right hand grip the handle section 28c on its side remote from the driver, while the thumb of the right hand grips the handle section 28c on its side which faces the driver.

A first switch 32, which can be rotated about a first switch axis of rotation 30, is also arranged at the free longitudinal end 28a of the handle part 28. This switch 32 has two projections 32a and 32b, which are spaced apart from one another in the circumferential direction of the switch 32, and between which the thumb of the right hand can be placed, with the result that the switch 32 can be rotated about the first switch axis of rotation 30 owing to the interlocking engagement with the thumb both in the clockwise direction and also in the anticlockwise direction. The switch axis of rotation 30 essentially coincides with a central axis of the handle section 28c.

In this case, the switch 32 may be connected to a controller of the industrial truck such that the industrial truck begins its forward travel when the switch 32 is rotated towards the front side of the vehicle, while the industrial truck begins its reverse travel when the switch 32 is rotated in the opposite direction. The switch 32 is also prestressed by means of spring prestress into its neutral position, illustrated in FIG. 1. The deflection travel of the switch 32 from this neutral position is proportional to the speed at which the industrial truck is driven in the selected direction.

Provided offset from the handle part 28 in the forward travel direction VF is a second switch 34 which is mounted such that it can rotate about a second switch axis of rotation 36. The second switch 34 is also prestressed by means of spring prestress into a neutral position from which it can be deflected into two opposite directions of rotation.

In the example illustrated in FIG. 1, the second switch 34 serves the purpose of actuating a lifting drive for a load-receiving means such that the load-receiving means is lifted when the second switch 34 is rotated about the second switch axis of rotation 36 in a first direction of rotation and is lowered when it is rotated about a second direction of rotation which is opposite to the first direction of rotation.

The second switch 34 is in this case arranged such that it can be reached and actuated by an index finger of the hand of the driver of the industrial truck which grips the handle section 28c without the hand having to change its position on the handle section 28c. In particular, no sliding of the hand along the handle section 28c is required. The driver of the industrial truck can maintain a firm grip on the handle part 28 throughout operation of the industrial truck i.e. when driving the industrial truck and when displacing a received load. This considerably increases the safety of the driver of the industrial truck.

The second rotary switch 34 has a design which is particularly advantageous for the application shown in FIG. 1: the switch 34 is in the form of a twin-lever switch having a first lever arm 34a, which lies upstream of the second switch axis of rotation 36, with respect to a direction of view in FIG. 1, and a second lever arm 34b, which lies downstream of the second switch axis of rotation 36 with respect to a direction of view in FIG. 1.

The first lever arm 34a, which lies above the second switch axis of rotation 36, when viewed from a standing area for the industrial truck, lies closer to the handle section 28c of the handle part 28 than the second lever arm 34b which is lower, when viewed from a standing area for the industrial truck. In order to make it easier to reach the second lever arm 34b by means of preferably the index finger of a hand gripping the handle section 28c of the handle part 28, this index finger projects in the axial direction, i.e. in the direction of the second switch axis of rotation 36, beyond the first lever arm 34a.

The above-described design of the second switch 35 has the following advantage: a finger which is extended from a hand gripping the handle section 28c may apply a greater compression force than the shearing force. Compression force is in this case taken to mean a force which can be transmitted from the finger, via the inner side of the fingertip, which bears the fingerprint, to an object which bears against this side. On the other hand, shearing force is understood to mean a force which can be transmitted from a side having the fingernail to an object bearing against this side. Owing to the design of the second switch 34, said second switch 34 can be rotated in each case owing to compression force of a finger in two opposite directions of rotation about the second switch axis of rotation 36, which makes it considerably easier to actuate the switch 34. Owing to the fact that the second lever arm 34b protrudes in the axial direction beyond the first lever arm 34a, said first lever arm 34a can be reached comfortably by the extended finger of the hand gripping the handle section 28c without the first lever arm 34a interfering in the process.

It should be noted that at least that region of the second switch 34 which can be reached by a finger, preferably the entire switch 34, has no sharp edges and only has curves having a comparatively large radius so as to rule out any risk of injury when actuating the two lever sections 34a and 34b in a different sequence.

It can be seen in FIG. 1 that the switch 34 lies closer to the standing area for the industrial truck than the handle part section 28c. The reason for this is the fact that an index finger of a hand, which grips the handle section 28c as comfortably as possible, when extended points forwards and downwards and possibly also slightly outwards in the transverse direction of the vehicle.

Express reference is made to the fact that, in the case of biometric specifications, such as “in the case of a handle section gripped by a hand [the switch] can be reached and actuated by a finger of this hand”, the bodily dimensions of an average adult, preferably male, person should be used as a basis. The use of average bodily dimensions is usual in designing control panels or, generally workplaces.

In the example shown, the second switch axis of rotation 36 encloses, with a vehicle transverse plane FQE which is orthogonal both with respect to the longitudinal central plane LME and with respect to the standing area, an angle β with respect to a tipping axis 38 which is orthogonal with respect to the standing plane, said angle β being 23° in the present example.

It has likewise been shown that the second switch 34 can be reached and actuated in a particularly simple manner from the handle part 28 by the index finger of a hand gripping the handle section 28c when the second switch axis of rotation 36 encloses, with the first switch axis of rotation 30, an angle γ of 5°, when viewed orthogonally with respect to the standing area for the industrial truck.

An emergency-off switch 40 is also arranged in the vicinity of the handle part 28 in order to render the industrial truck completely still if necessary, using a single actuating step. Provided in the vicinity of the second switch 34, preferably offset in the direction of the second switch axis of rotation 36 towards the longitudinal central plane LME, is a further switch 42 which can likewise still be reached by the index finger of a hand gripping the handle section 28c. Owing to the pushbutton switch 42, a horn can sound, for example, when said switch is depressed, or the switch 42 can be used for the purpose of switching on and off a vehicle lighting system.

As is indicated by a dashed line surrounding the second switch 34 in the form of a quarter circle, the second switch 34 is arranged in a depression 44 in the control panel 10. It goes without saying that the second switch 34 can also be actuated and gripped without at the same time gripping the handle section 28c.

FIG. 2 shows the control panel region, which comprises the handle part 28 and the second switch 34, in a perspective illustration when viewed by a driver standing behind the handle part with a direction of view in the forward travel direction and towards the standing area.

In contrast to the illustration in FIG. 1, the thumb contact projections 32a and 32b of the switch 32 in FIG. 2 protrude into the handle section 28c in order to be capable of being reached more easily by a thumb of a hand gripping the handle section 28c.

1. Industrial truck having a steering wheel which can be rotated about a steering wheel axis of rotation, the steering wheel axis of rotation being rotated a predetermined angle of rotation (α) with respect to an imaginary plane (LME), which is orthogonal with respect to a standing area for the industrial truck, passes through a driver's platform and extends in the longitudinal direction of the industrial truck, about a rotational axis which is essentially orthogonal with respect to the standing area and lies on the imaginary plane, wherein the steering wheel axis of rotation is rotated away from the driver, the rotational axis being positioned in the forward travel direction (VF) of the industrial truck, when viewed from the driver's platform.

2. Industrial truck according to claim 1, wherein the imaginary plane (LME) is a longitudinal central plane (LME) of the industrial truck.

3. Industrial truck according to claim 1, wherein the steering wheel axis of rotation is essentially parallel to the standing area for the industrial truck.

4. Industrial truck according to claim 1, wherein the angle of rotation (α) between the steering wheel axis of rotation and the imaginary plane (LME) is 5° to 15°, preferably approximately 10°.

5. Industrial truck having a handle part, on which a first movable switch is provided for the purpose of controlling a controllable first component of the industrial truck such that it can be reached and actuated by a first finger of the hand gripping the handle part when a handle section of the handle part is gripped by a hand, and wherein a second movable switch which is separate from the first movable switch is provided on the industrial truck for the purpose of controlling a controllable second component, which is different from the first component, of the industrial truck such that it can be reached and actuated by a second finger, which is different from the first finger, of the hand gripping the handle part when the handle section of the handle part is gripped by the hand.

6. Industrial truck according to claim 5, wherein the first switch and the second switch are rotary switches which can be actuated by rotating them about respective rotary switch axes.

7. Industrial truck according to claim 6, wherein the handle section is symmetrical, at least in sections, with a handle section central axis, the rotary switch axis of the first rotary switch extending essentially coaxially with respect to the handle section central axis.

8. Industrial truck according to claim 6, wherein the rotary switch axis of the second rotary switch is tipped at an angle (γ) of −5° to +10°, preferably 0° to +7.5°, particularly preferably approximately 5°, with respect to the rotary switch axis of the first rotary switch about a tipping axis which is essentially orthogonal with respect to the standing area for the industrial truck, the rotary switch axis of the first rotary switch acting as the reference axis, from where positive angles are measured in the anticlockwise direction.

9. Industrial truck according to one of claim 5, wherein the rotary switch axis of the second rotary switch encloses, with a reference plane (FQE) which is orthogonal both with respect to the longitudinal direction of the industrial truck and with respect to its standing area and contains the point of intersection between the rotary switch axis of the second rotary switch and the longitudinal central plane (LME) of the industrial truck, an angle (β) of approximately 15° to 30°, preferably from 20° to 25°, particularly preferably of approximately 23°, whereby positive angles are intended to be measured from the reference plane in the clockwise direction.

10. Industrial truck according to claim 5, wherein the second switch is arranged lower than the first switch, when viewed from the standing area for the industrial truck.

11. Industrial truck according to claim 5, wherein the first switch is arranged upstream of the second switch in the longitudinal direction of the industrial truck, when viewed from the driver's platform of the industrial truck.

12. (canceled)

13. Industrial truck according to claim 1, further comprisng a control panel having the steering wheel.

14. Industrial truck according to claim 5, further comprising a control panels having the first switch and the second switch.

15. Industrial truck having a control panel that includes a steering wheel which can be rotated about a steering wheel axis of rotation, the steering wheel axis of rotation being rotated a predetermined angle of rotation (α) with respect to an imaginary plane (LME), which is orthogonal with respect to a standing area for the industrial truck, passes through a driver's platform and extends in the longitudinal direction of the industrial truck, about a rotational axis which is essentially orthogonal with respect to the standing area and lies on the imaginary plane, wherein the steering wheel axis of rotation is rotated away from the driver, the rotational axis being positioned in the forward travel direction (VF) of the industrial industrial truck, when viewed from the driver's platform, and wherein the control panel further includes a handle part, on which a first movable switch is provided for the purpose of controlling a controllable first component of the industrial truck such that it can be reached and actuated by a first finger of the hand gripping the handle part when a handle section of the handle part is gripped by a hand, and a second movable switch which is separate from the first movable switch is provided on the industrial truck for the purpose of controlling a controllable second component, which is different from the first component, of the industrial truck such that it can be reached and actuated by a second finger, which is different from the first finger, of the hand gripping the handle part when the handle section of the handle part is gripped by the hand.
